(19) United States
(12) Patent Application Publication
(10) Pub. No.: US 2026/0270712 A1
(43) Pub. Date: Sep. 10, 2026

(54) INTEGRATION OF LOCATION VALIDATION FOR NON-NOMADIC BROADCASTING DISTRIBUTION

(71) Applicant: TCHERNOBRIVETS INC., Aurora (CA)

(72) Inventor: Alexei Tchernobrivets, Aurora (CA)

(21) Appl. No.: 19/557,969

(22) Filed: Mar. 5, 2026

Related U.S. Application Data
(60) Provisional application No. 63/830,150, filed on Jun. 25, 2025.

(30) Foreign Application Priority Data
Mar. 5, 2025 (CA) 3266887

(51) Int. Cl. H04W 12/64; H04W 64/00

(52) U.S. Cl. CPC H04W 12/64; H04W 64/00

(57) ABSTRACT

There is disclosed herein systems, methods, and non-transitory computer-readable media for enforcing non-nomadic access to digital content distribution services. A locating technology module is associated with a content receipt device configured to access video, audio, or on-demand content. The locating technology module generates location data representing a physical location of the device. Registered location coordinates corresponding to an authorized physical location are stored in secure storage. A backend server validates the location data against the registered location coordinates and authorizes access to the content distribution service only when the device is determined to be at the authorized location. Access is restricted when a location mismatch, tampering, or spoofing condition is detected.

### FIELD

The present disclosure relates generally to systems, devices, and methods for enforcing geographic and regulatory restrictions associated with digital content provision while maintaining permissible user access to such content. More particularly, the disclosure relates to integrating locating technology with content receipt and playback devices to enable and enforce non-nomadic access to content distribution services, including Internet Protocol Television (IPTV), on-demand, and/or audio services, in a manner consistent with regional regulatory requirements, content licensing constraints, and service agreements.

### BACKGROUND

Digital distribution of television, video, and audio content often involves contractual and regulatory obligations that restrict where content may be accessed. For example, service agreements and content licensing arrangements may require that content access be limited to designated geographic regions and/or to specific physical premises, creating a need for mechanisms that ensure compliance with geographic restrictions while still permitting authorized users to access services as intended.

Existing approaches to geographic restriction frequently rely on network-based or internet-based geolocation techniques. However, such techniques may be circumvented (for example, through VPNs or proxy services), and are therefore insufficient to reliably verify the physical location of a service-delivery device. This can create compliance challenges for providers that must enforce regional restrictions and/or non-nomadic service models due to content licensing, regulatory requirements, and service agreements.

Additionally, known solutions may not provide consistent and ongoing enforcement of location restrictions in a manner that is tamper-resistant, adaptable, and suitable for a range of consumer devices used for content receipt and playback. In particular, existing solutions may not adequately address the need for continuous or periodic location validation tied to the content receipt device itself, nor do they necessarily provide robust mechanisms to deter or detect end-user attempts to bypass location enforcement.

Accordingly, there remains a need for improved systems and methods that leverage locating technology (e.g., GPS and analogous technologies) to enforce a non-nomadic model for content delivery by ensuring that a Smart TV, media player, set-top box, or similar content receipt device operates only at a predefined and authorized location, and that service access can be disabled or otherwise restricted when location validation fails or is inconsistent with registered coordinates.

### SUMMARY OF THE INVENTION

Disclosed herein are systems, methods, and non-transitory computer-readable media for enforcing non-nomadic access to digital content distribution services, including IPTV, on-demand, and/or audio services, delivered to content receipt and playback devices such as Smart TVs, media players, and set-top boxes.

In one aspect, a locating technology module, including without limitation GPS or analogous location-determination technology, is integrated with, built into, electronically connected to, or otherwise associated with a content receipt device. The locating technology module is configured to obtain location data representative of the physical location of the device.

The system further comprises secure storage for maintaining one or more registered location coordinates corresponding to an authorized physical location. A backend server or backend system, which may be implemented using cloud-based infrastructure, is configured to validate location data obtained from the locating technology module against the registered location coordinates and to authorize access to the content distribution service based on the validation result.

In another embodiment, the disclosure provides a method for enforcing non-nomadic access to content distribution services. The method includes obtaining location data from the locating technology module; securely storing registered location coordinates; validating the obtained location data against the registered location coordinates; enabling access to the content distribution service only when the validated location corresponds to the authorized location; and restricting, suspending, or disabling access to the service when a location mismatch is detected.

In some embodiments, location validation is performed continuously, periodically, or in response to defined events, including at device startup or during active service use. In further embodiments, the method includes cooperation with the backend server to manage registered locations, perform validation, and authorize or deny service access.

In certain embodiments, the systems and methods may comprise tamper-resistance and fraud-mitigation features, such as detection of locating technology removal or interference, validation of location data integrity, mitigation of spoofed location signals, and corroboration of location data using additional sources of information. In some embodiments, limited service access may be temporarily permitted based on a last known valid location during transient signal loss, with re-validation required before full service is restored.

The disclosed systems and methods provide device-level enforcement of geographic restrictions, enabling reliable compliance with non-nomadic regulatory requirements, regional content licensing constraints, and service agreements, while maintaining authorized user access within approved physical locations.

### BRIEF DESCRIPTION OF THE DRAWINGS

The accompanying drawings, which are incorporated herein and form part of the present disclosure, illustrate exemplary embodiments of systems and methods for enforcing non-nomadic access to digital content distribution services. The drawings are provided by way of illustration only and are not intended to limit the scope of the invention as defined by the claims.

FIG. 1 is a schematic block diagram illustrating an exemplary system for enforcing non-nomadic access to content distribution services using a locating technology module integrated with a content receipt device and a backend server.

FIG. 2 is a flow diagram illustrating an exemplary location registration and validation process, including secure storage of registered location coordinates.

FIG. 3 is a flow diagram illustrating an exemplary method for enforcing non-nomadic access to content distribution services based on validation of location data.

FIG. 4 is a schematic diagram illustrating exemplary security, integrity, and tamper-resistance mechanisms associated with the locating technology module and content receipt device.

### DETAILED DESCRIPTION

The embodiments described herein relate to systems and methods for enforcing non-nomadic use of digital content distribution services by tying service access to a verified physical location of a content receipt and/or playback device. In various embodiments, the content receipt and/or playback device may include, without limitation, a Smart TV, media player, set-top box (STB), or other device capable of receiving, rendering, or enabling access to Internet Protocol Television (IPTV), on-demand, and/or audio services.

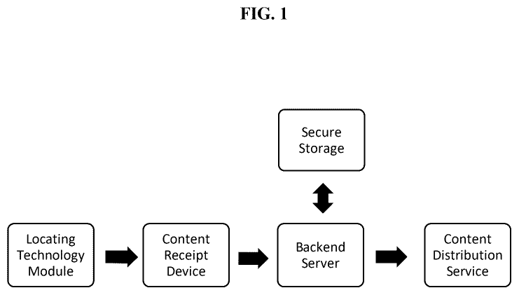

As illustrated in FIG. 1, an exemplary system for enforcing non-nomadic access includes a locating technology module, a content receipt device, secure storage for maintaining registered location coordinates, a backend server, and a content distribution service. The components may be integrated within a single device or distributed across multiple devices and systems, depending on implementation.

As used herein, “Locating Technology” includes Global Positioning System (GPS) technology and/or analogous location-determination technologies, alone or in combination, capable of generating location information (“Location Data”) associated with a device. In some embodiments, the locating technology is implemented via a hardware module (the “Module”) that is built into, attached to, or electronically connected with the content receipt device. In other embodiments, the locating technology may be provided by a substantially co-located device that supplies Location Data to the content receipt device.

In some embodiments, the backend server is implemented using cloud-based infrastructure and is configured to receive Location Data, validate the Location Data against registered location coordinates, and authorize or deny access to the content distribution service based on the validation result, as shown in FIG. 1.

In some embodiments, the Module includes a GPS receiver or other locating technology receiver that is (a) integrated within the content receipt device, or (b) connected through an interface such as USB or other communication protocols. By way of non-limiting example, suitable interfaces may include USB, Wi-Fi, Bluetooth, UART, or embedded hardware implementations. Power for the Module may be supplied by the host device or via an independent power source.

In some embodiments, the content receipt device executes software, an application, or a service capable of communicating with the Module to obtain Location Data. Such software may utilize operating system or application programming interfaces (APIs), including hardware abstraction interfaces, to access the locating technology and retrieve Location Data. Location Data may be supplied in formats such as NMEA sentences or other locating-technology-specific data formats, which may be parsed to extract latitude, longitude, and related parameters.

In some embodiments, an initial registration process associates the content receipt device with an authorized physical location. During registration, a user may provide an address or location, and the system may validate that information against Location Data obtained from the Module. Upon successful validation, the corresponding coordinates are stored as registered location coordinates.

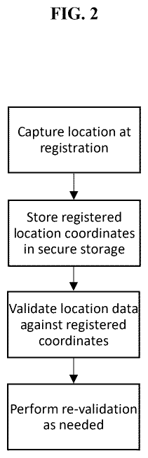

As illustrated in FIG. 2, registered location coordinates may be stored in secure storage, which may include encrypted storage, hardware-backed secure elements, a Trusted Platform Module (TPM), or similar security mechanisms. The system may support subsequent re-validation of the device location against the registered coordinates, including re-validation triggered by defined events such as device restart, detected tampering, or backend server requirements.

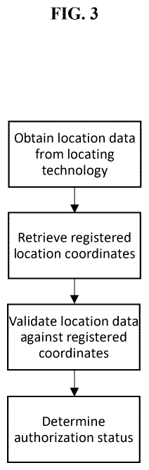

During operation, the system validates current Location Data against the registered location coordinates to enforce non-nomadic access. With reference to FIG. 3, in some embodiments the system performs a location-validation process that includes obtaining current Location Data from the Module, retrieving the registered location coordinates, comparing the current Location Data to the registered coordinates (including within an acceptable threshold), and determining whether access to the content distribution service should be enabled or restricted.

In some embodiments, location validation is performed at device startup. In some embodiments, validation is performed periodically during operation, thereby providing continuous or near-continuous enforcement of the non-nomadic model. If the current Location Data corresponds to the registered location coordinates, access to the content distribution service is enabled. If the Location Data deviates from the registered coordinates, access may be restricted, suspended, or disabled.

In some embodiments, the content receipt device communicates Location Data and/or derived validation results to the backend server, which performs an independent validation and authorizes or denies service access accordingly.

In some embodiments, a method for enforcing non-nomadic usage of a content distribution service includes obtaining Location Data from a locating technology module associated with a content receipt device; securely storing registered location coordinates corresponding to an authorized physical location; validating current Location Data against the registered location coordinates; enabling access to the content distribution service when the Location Data corresponds to the authorized physical location; and restricting access to the content distribution service when the Location Data does not correspond to the registered location coordinates.

In some embodiments, one or more of the foregoing operations may be performed at device startup, periodically during device operation, in response to detected events, or in cooperation with a backend server. The operations may be performed in hardware, software, firmware, or any combination thereof, and the order of operations is not limiting.

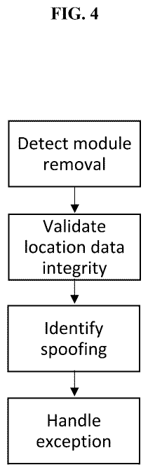

Referring to FIG. 4, in some embodiments the system includes security, integrity, and tamper-resistance mechanisms to deter or detect attempts to circumvent location enforcement. Such mechanisms may include monitoring the physical or logical presence of the Module to detect removal, replacement, or disconnection, and restricting service access in response to such events.

In some embodiments, integrity mechanisms—such as digital signatures, cryptographic validation, or checksum verification—are used to validate the integrity of Location Data and to reject corrupted or unauthorized data. In some embodiments, the system detects and mitigates spoofed or emulated location signals using signal validation techniques.

In some embodiments, Location Data may be corroborated using one or more additional sources of location-related information, such as Wi-Fi triangulation and/or IP address geolocation, to reduce susceptibility to circumvention.

In some embodiments, the system detects loss of locating signals (for example, GPS signal loss) using a timeout or similar mechanism. During transient signal loss, the system may temporarily permit limited service access based on a last known valid location. Re-validation may be required before full service access is restored, particularly following signal recovery, detected tampering, or a location mismatch event.

While certain embodiments describe a Module directly integrated with a content receipt device, in other embodiments the system may obtain Location Data from a substantially co-located device that includes locating technology. In such embodiments, non-nomadic access may still be enforced by validating the location of the co-located device against the registered location coordinates.

The embodiments described herein may be implemented in hardware, software, firmware, or any combination thereof, and may be embodied in non-transitory computer-readable media storing instructions that, when executed by one or more processors, perform the disclosed methods.

1. A system for enforcing non-nomadic access to a content distribution service, the system comprising:
a. a content receipt device configured to receive or enable access to at least one of video, audio, or on-demand content;
b. a locating technology module associated with the content receipt device and configured to generate location data representative of a physical location of the content receipt device;
c. secure storage configured to store registered location coordinates corresponding to an authorized physical location; and
d. a backend server configured to validate the location data against the registered location coordinates and to authorize access to the content distribution service only when the location data corresponds to the authorized physical location.

2. The system of claim 1, wherein the locating technology module comprises a GPS-based locating device.

3. The system of claim 1, wherein the locating technology module is integrated within the content receipt device.

4. The system of claim 1, wherein the locating technology module is electronically connected to the content receipt device via an external interface.

5. The system of claim 1, wherein the locating technology module is included in a substantially co-located device and provides the location data to the content receipt device.

6. The system of claim 1, wherein the backend server is implemented using cloud-based infrastructure.

7. The system of claim 1, wherein access to the content distribution service is disabled when the locating technology module is removed, disconnected, or determined to be invalid.

8. The system of claim 1, further comprising software executed by the content receipt device to parse the location data and communicate validation information to the backend server.

9. The system of claim 1, wherein the secure storage comprises encrypted storage or hardware-backed secure storage.

10. A method for enforcing non-nomadic access to a content distribution service, the method comprising:
a. obtaining location data from a locating technology module associated with a content receipt device;
b. retrieving registered location coordinates corresponding to an authorized physical location;
c. validating the location data against the registered location coordinates;
d. enabling access to the content distribution service when the location data corresponds to the authorized physical location; and
e. restricting access to the content distribution service when the location data does not correspond to the authorized physical location.

11. The method of claim 10, wherein validating the location data is performed at startup of the content receipt device.

12. The method of claim 10, wherein validating the location data is performed periodically during operation of the content receipt device.

13. The method of claim 10, further comprising storing the registered location coordinates in secure storage during an initial registration process.

14. The method of claim 10, further comprising detecting removal or tampering of the locating technology module and restricting access to the content distribution service in response.

15. The method of claim 10, further comprising validating integrity of the location data prior to authorizing access.

16. The method of claim 10, further comprising detecting spoofed or emulated location data.

17. The method of claim 10, further comprising corroborating the location data using at least one additional source of location-related information.

18. The method of claim 10, further comprising temporarily permitting access to the content distribution service based on a last known valid location during transient loss of the location data, and requiring re-validation before restoring full access.

19. A non-transitory computer-readable medium storing instructions which, when executed by one or more processors, cause performance of the method of claim 10.
